(19) United States
(12) Patent Application Publication
(10) Pub. No.: US 2009/0073397 A1
(43) Pub. Date: Mar. 19, 2009

(54) Laminar Flow Gas Curtains for Lithographic Applications

(75) Inventors: Herman Vogel, Sandy Hook, CT (US); Michael Parisi, Trumbull, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V.

(21) Appl. No.: 12/191,717

(22) Filed: Aug. 14, 2008

Related U.S. Application Data
(63) Continuation-in-part of application No. 12/121,076, filed on May 15, 2008, now abandoned.
Application No. 12/121,076 is a continuation of application No. 11/170,067, filed on Jun. 30, 2005, now Pat. No. 7,375,791.

(51) Int. Cl. G03B 27/52

(52) U.S. Cl. 355/30

(57) ABSTRACT

Laminar flow gas curtains can be used in a lithographic apparatus to maintain a gaseous purity level within one or more components of the lithographic apparatus such as, for example, a wafer stage and a wafer handler system. In an embodiment, a method to design a flow conditioning channel for use in such gas curtains can include selecting a kinetic purge power (KPP) factor based on a predefined throw distance (L′) to a channel length (L) ratio (L′L), selecting the channel length (L) to a channel diameter (D) ratio (L/D) based on the KPP factor, determining the channel length for the predefined throw distance based on the (L′/L) ratio, and determining the channel diameter D based on the channel length to the channel diameter (L/D) ratio and the channel length L The channel length L and channel length D can be designed based on a predetermined nozzle exit Reynold's number.

### CROSS-REFERENCE TO RELATED APPLICATIONS

This application is a continuation-in-part application of U.S. application Ser. No. 12/121,076, filed May 15, 2008, which is a continuation application of U.S. application Ser. No. 11/170,067, filed Jun. 30, 2005, now U.S. Pat. No. 7,375,791 that issued May 20, 2008, both of which are incorporated by reference herein in their entireties.

### FIELD OF THE INVENTION

The present invention relates generally to lithography. More particularly, it relates to laminar flow gas curtains for lithography applications.

### BACKGROUND

Gas curtains are used in a variety of applications. In lithographic applications, they are used to maintain required gaseous purity levels within selected components such as the wafer stage and the wafer handling systems. Another example of gas curtain use is to provide thermally stable environments to facilitate interferometry measurements.

Available gas curtain systems, however, are inefficient because of the ease with which the purging gas mixes with environmental gases during the purge process. The gas used to form a gas curtain is a consumable, and the inefficient use of gas by available gas curtain systems adds to the overall cost of lithographic throughput.

### SUMMARY

What is needed for lithographic applications are new gas curtain systems that overcome the limitations and drawbacks of currently available gas curtain systems.

In an embodiment of the present invention, a method to design a flow conditioning channel for a gas curtain system includes selecting a kinetic purge power (KPP) factor based on a predefined throw distance (L′) to a channel length (L) ratio (L′/L), selecting the channel length (L) to a channel diameter (D) ratio (L/D) based on the KP factor, determining the channel length L for the predefined throw distance L′ based on the (L′L) ratio, and determining the channel diameter D based on the channel length to the channel diameter (L/D) ratio and the channel length L.

In one embodiment, the method can also include verifying the channel length L and the channel diameter D are within a predetermined range of nozzle exit Reynold's numbers (Re) for a nozzle (e.g., 60<Re<120). In verifying the channel length L and the channel diameter D, the following equation can be used to define the nozzle exit Reynold's number:

$$Re = \frac{ρ \cdot {V}_{e} \cdot D}{μ}$$

where ρ is a coolant density parameter, Vₑ is an exit velocity of the nozzle, and μ is a coolant dynamic viscosity parameter.

In one embodiment, the method can also include determining the channel length L and the channel diameter D for a predefined Reynold's number such as, for example, a maximum nozzle exit Reynold's number. In one example, when selecting the KPP factor, the predefined throw distance to the channel length (L′/L) ratio can be selected from a correlation between a purge dilution factor and the KPP factor of a nozzle to move air or gas at a specified velocity. Further, in selecting the channel length L, the channel length to the channel diameter (L/D) ratio can be based on a predefined purge dilution factor.

In another embodiment, a lithographic apparatus can include the following: an illumination source configured to emit an illumination energy; a spatial light modulator configured to receive the illumination energy; projection optics configured to receive an illumination energy reflected from the spatial light modulator; and, a wafer stage configured to receive the illumination energy from the projection optics. The wafer stage includes a gas curtain having a nozzle. The nozzle is designed based on the following: selecting a kinetic purge power (KPP) factor based on a predefined throw distance (L′) to a channel length (L) ratio (L′/L), selecting the channel length (L) to a channel diameter (D) ratio (L/D) based on the KP factor, determining the channel length L for the predefined throw distance L′ based on the (L′L) ratio, and determining the channel diameter D based on the channel length to the channel diameter (L/D) ratio and the channel length L.

Further features and advantages of the present invention, as well as the structure and operation of various embodiments of the present invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable persons skilled in the pertinent art(s) to make and use the invention. In the drawings, like reference numbers indicate identical or functionally similar elements. Additionally, the left-most digit(s) of a reference number identifies the drawing in which the reference number first appears.

FIG. 1 is a schematic diagram of a lithographic tool having a gas curtain system according to an embodiment of the present invention.

FIG. 2A is a schematic diagram of the nozzle of the gas curtain system of FIG. 1.

FIGS. 2B and 2C are schematic diagrams of a gas curtain system according to an embodiment of the present invention.

FIG. 3 is a schematic diagram of the first housing and the flow distribution plate of the nozzle of FIG. 2.

FIG. 4 is a schematic diagram showing the flow of gas through the nozzle of FIG. 2.

FIG. 5 is a diagram illustrating how the flow conditioning channels of a nozzle according to an embodiment of the present invention can be formed by a plurality of plates.

FIG. 6 is a graph of critical Reynolds numbers above which eddies are produced, and which shows dependency on the solidity of a screen.

FIG. 7 is a graph of the scale of shedding vortices downstream of a grid of wire as a function of distance from the grid.

FIG. 8 is a graph of variations of cooling effectiveness or lack of mixing between two parallel flowing gas-streams.

FIG. 9 is a graph of velocity distribution in a zone between two interlacing parallel flow streams, and it represents a measure of their mixing potential.

FIG. 10 is a graph illustrating a gas curtain throw distance as a function of flow conditioning channel length, kinetic purge power, and required purge dilution factor.

FIG. 11 is a graph illustrating flow conditioning channel length as a function of flow conditioning channel diameter, kinetic purge power, and required purge dilution factor.

FIG. 12 is an illustration of a method to design a flow conditioning channel according to an embodiment of the present invention

### DETAILED DESCRIPTION

The present invention provides laminar flow gas curtains for use in lithographic applications. In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

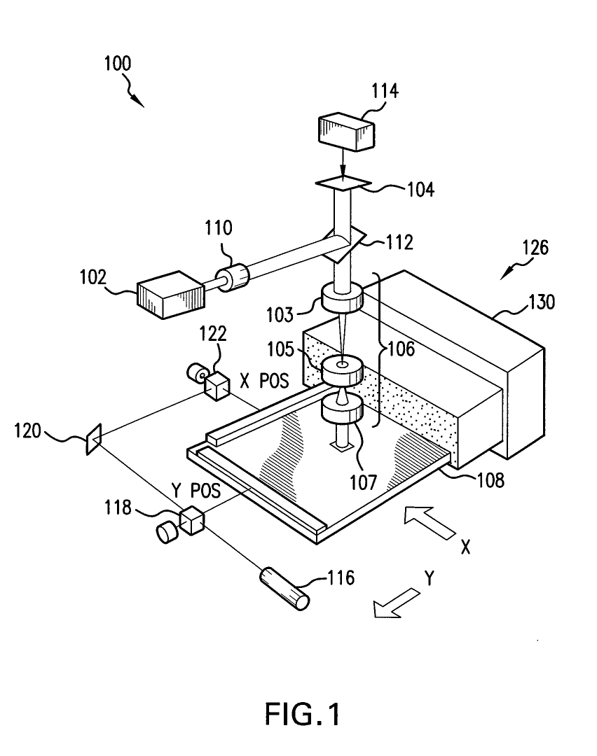

FIG. 1 is a schematic diagram of a lithography tool 100 according to an embodiment of the present invention. Tool 100 includes an illumination source 102, a spatial light modulator 104, projection optics 106, a wafer stage 108, and a gas curtain system 126. Although lithography tool 100 is a maskless lithography tool, the present invention is not limited to only maskless tools. The present invention includes and can be used with all lithographic tools.

In an embodiment, illumination energy emitted by illumination source 102 is conditioned by illumination optics 110. Illumination energy exiting illumination optics 110 is directed to spatial light modulator 104 using a beam-splitter 112. In an embodiment, illumination source 102 is a pulsed excimer laser. A continuous illumination source also can be employed.

Spatial light modulator 104 is a reflective type spatial light modulator that includes a plurality of spatial light modulator cells (not shown). A pattern rasterizer 114 coupled to spatial light modulator 104 applies a signal to each of the spatial light modulator cells to form a die pattern. When applied to spatial light modulator 104, the signal produces a linearized pattern bitmap.

Illumination energy reflected from spatial light modulator 104 passes through beam-splitter 112 and enters projection optics 106. As shown in FIG. 1, in one embodiment, projection optics 106 includes a lens or lens group 103, an aperture 105, and a lens or lens group 107. A die image is formed using reflected illumination energy from the spatial light modulator cells that enters a pupil of projection optics 106.

Wafer stage 108 is moveable in the X and Y directions to permit step and scan lithography. The Y-direction position is controlled using motors (not shown) and interferometer 118. The X-direction position is controlled using motors (not shown) and interferometer 122. A laser 116 and a beam-splitter 120 are used to provide illumination to interferometer 118 and interferometer 122. The images formed by projection optics 106 can be located at different areas of wafer stage 108 by changing the position of wafer stage 108.

In an embodiment of the present invention, a spatial light modulator is used that controls the transmission or passage of illumination energy rather than the reflection of illumination energy. In this embodiment, the illumination optics are rearranged to appropriately illuminate the spatial light modulator.

Gas curtain system 126 includes a nozzle 130 and a source of gas (not shown). Gas curtain system 126 is used, for example, to purge wafer stage 108 and/or to control heat that would otherwise effect the operation of interferometers 118 and 122. The gas curtain (e.g., an air curtain) generated by gas curtain system 126 prevents hot ambient-air from penetrating and mixing within the interferometric control volume of lithographic tool 100, thereby preventing adverse index of refraction changes.

It is noted here that the size of nozzle 130, as well as the other components of lithography tool 100, are not drawn to scale.

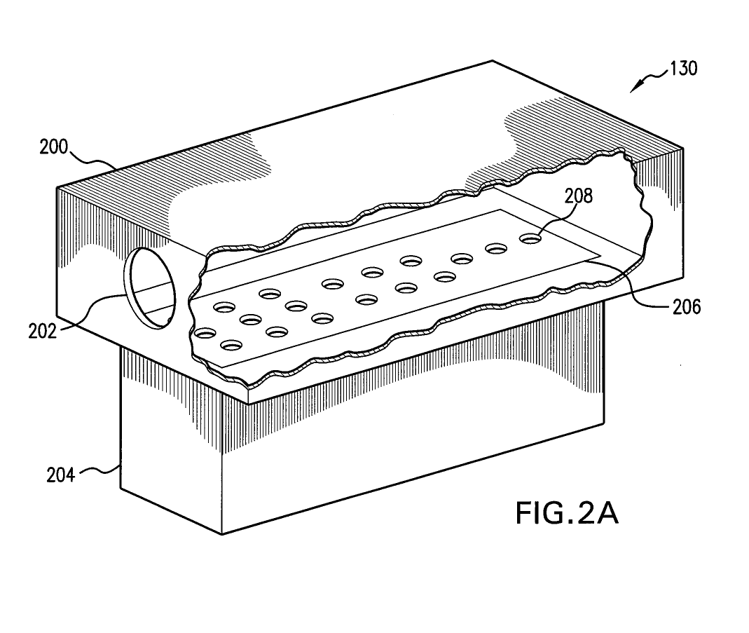

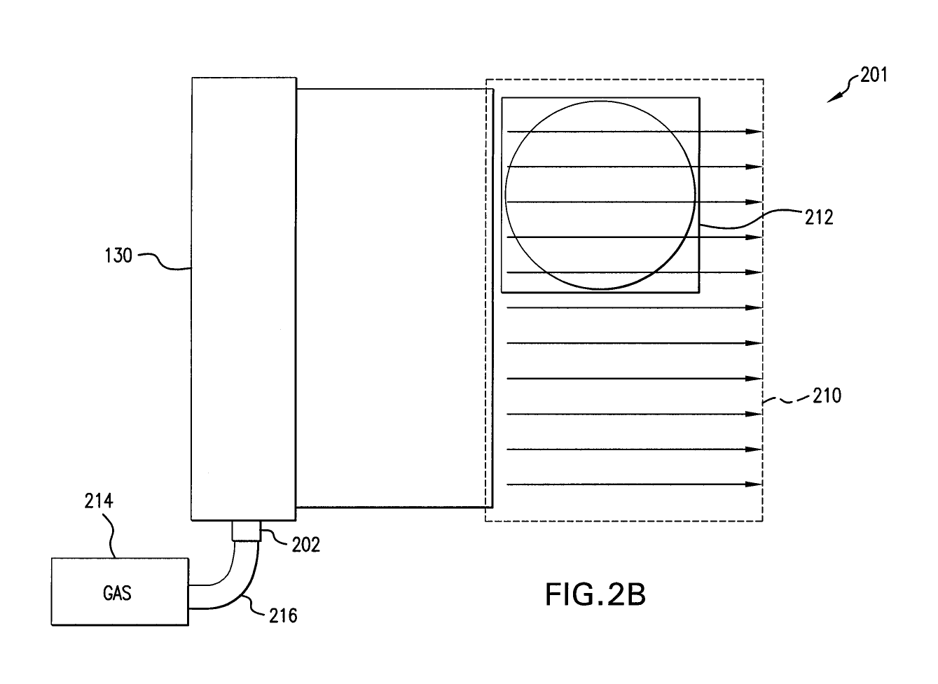

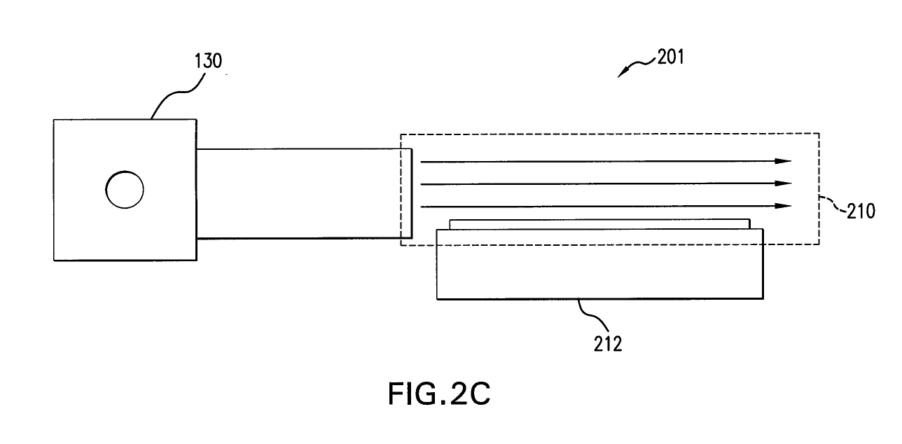

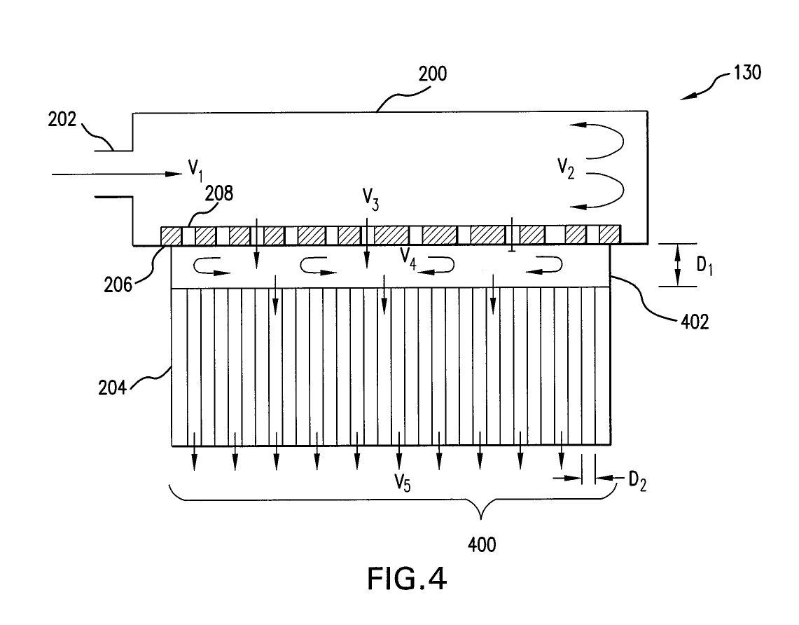

FIG. 2A is a schematic diagram of nozzle 130. As shown in FIG. 2A, nozzle 130 includes a first housing 200, a second housing 204, and a flow distribution plate 206. Nozzle 130 also includes a plurality of flow conditioning channels (see, e.g., FIG. 4), which are described below.

Housing 200 has an inlet 202 and is fluidly coupled to housing 204 through flow distribution plate 206. As shown in FIG. 2A, in a preferred embodiment, housing 200 and housing 204 are rectangular. Other shapes are used in other embodiments.

As shown in FIG. 2A, flow distribution plate 206 includes a plurality of holes 208. The size, number, and spacing of holes 208 in flow distribution plate 206 are selected to ensure that the flow of gas from first housing 200 is evenly distributed in the second volume enclosed by second housing 204.

In embodiments, the number of holes 208 per unit area is not uniform across flow distribution plate 206. This non-uniform distribution is based, for example, on the non-uniform pressures that exist in the first volume enclosed by housing 200. In the embodiment shown in FIG. 2A, the number of holes 208 per unit area is greatest at the end of flow distribution plate 206 near inlet 202, where the pressure in housing 200 is lowest. The number of holes 208 per unit area is lowest at the end of flow distribution plate 206 furthest from inlet 202, where the pressure is greatest.

FIG. 2B is a schematic diagram (top view) of a gas curtain system 201 that uses nozzle 130 to form a gas curtain 210. Gas curtain 210 is shown as forming a barrier for a wafer stage 212 of a step-and-scan lithography tool. As shown in FIG. 2B, inlet 202 is coupled to a source of gas 214 by a hose 216, or the like as would become apparent to persons skilled in the relevant art. Gas source 214 provides a flow of gas to nozzle 130 sufficient to maintain gas curtain 210 during operation of the lithography tool. FIG. 2C is a schematic diagram (side view) that further illustrates gas curtain system 201.

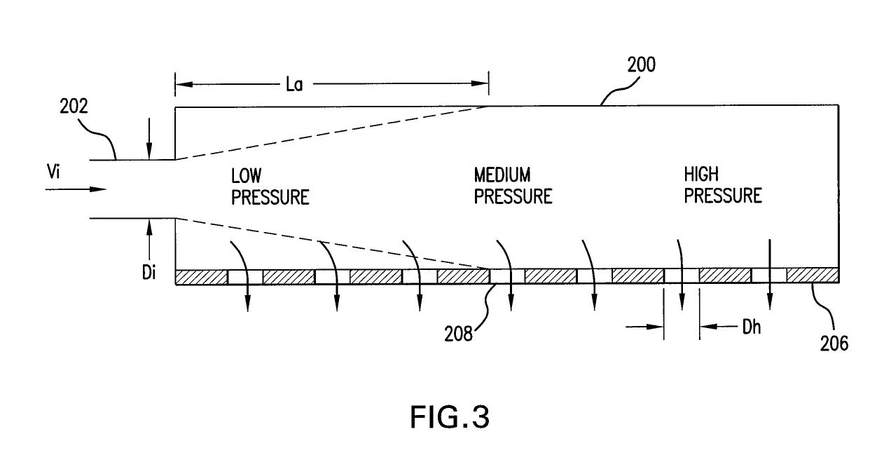

As shown in FIG. 3, a flow of gas enters first housing 200 through inlet 202. This flow of gas is distributed within a first volume enclosed by housing 200. Flow distribution plate 206 controls the distribution of the gas as it flows from housing 200 into housing 204 (see FIG. 2A) by applying a back-pressure to the entering flow-field.

The following example illustrates how to select parameters for housing 200 and flow distribution plate 206, according to an embodiment of the present invention, in order to achieve an appropriate back-pressure. For purposes of this example, consider a housing 200 having a length L, a width W, a height H, and an inlet diameter Dᵢ. The length Lₐ shown in FIG. 3 is at least 10 Dᵢ. The diameter of the holes in flow distribution plate 206 are Dₕ.

For this example, consider that the gas entering housing 200 is air at a flow rate of Vᵢ equals 52 cubic feet per minute (CFM). Based on the parameters noted above, the mass flow (mf) entering housing 200 is

$$mf = ρ \cdot V \cdot ( \frac{π \cdot {Dh}^{2}}{4} ) = 0.03 ( \frac{kg}{sec} ) ,$$

where

$$ρ = \frac{kg}{{m}^{3}}$$

and

$$V = \frac{m}{sec} .$$

The pressure drop is

$$Δ P = κ \cdot ρ \cdot \frac{{v}^{2}}{2} ,$$

where κ equals a head loss factor of 1. The volumetric flow rate is

$$Q = \frac{mf}{ρ} = V \cdot ( \frac{π \cdot {Dh}^{2}}{4} ) ,$$

where

$$mf = \frac{kg}{sec} , D = m ,$$

and

$$( \frac{mf}{A} = ρ \cdot V ) .$$

The pressure drop in housing 200 is based on inlet conditions and the geometry of housing 200. The pressure drop in Pascals is given by:

$$Δ P\_p = [ 1 + [ 4 \cdot ( \frac{5 \cdot L}{Di} ) \cdot f ] ] \cdot ( \frac{8 \cdot {mf}^{ 2}}{{π}^{2} \cdot {Di}^{4} \cdot ρ c} ) ,$$

where ƒ is a friction factor and the density of air (ρc) is equal to 1.2 kg/m³. Letting ReD equal the Reynolds Number, where ReD equals

$$( ρ \cdot v ) \cdot ( \frac{Dh}{μ c} ) = ( \frac{mf}{A} ) \cdot ( \frac{Dh}{μ c} ) = \frac{4 \cdot mf}{π \cdot Dh \cdot μ c} ,$$

the friction factor ƒ equals

$$\frac{16}{Re D}$$

if ReD is less than or equal to 2300 (laminar tube flow). The friction factor ƒ equals

$$f = 2.4 \cdot {10}^{- 8} \cdot {( \frac{e}{Dh} )}^{0.0118} .$$

ReD⁶¹⁴⁴ if ReD is greater than or equal to 2300 and less than or equal to 4000 (transition tube-flow from laminar through turbulent), where

$${10}^{- 7} \leq ( \frac{E}{Dh} ) \leq 0.1$$

(tube roughness) and e equals 2·10⁻⁶ (smooth tubes). The friction factor ƒ equals

$$\frac{1}{\sqrt{( 4 \cdot f )}} = 1.74 - 2.0 \cdot log [ 2 \cdot ( \frac{e}{Dh} ) + \frac{18.7}{\sqrt{( 4 \cdot f )}} \cdot \frac{1}{Re D} ]$$

for ReD greater than 4000.

The flow distribution plate pressure drop is given by:

$$ΔP\_h = 1.5 \cdot ( ρ \cdot \frac{{vp}^{2}}{2} ) = ( 1.5 + 4 \cdot \frac{Lp}{Dh} \cdot f ) \cdot ( \frac{8 \cdot mf}{{Nh}^{2} \cdot {Cd}^{2} \cdot {π}^{2} \cdot {Dh}^{4} \cdot ρ} ) ,$$

where Lp is the thickness of the flow distribution plate, Dh is the diameter of the holes in the flow distribution plate, Nh is number of holes, and Cd is the discharge coefficient of the holes.

Based on experiments, it has been determined that the following design guidelines produce appropriate flow distribution through a flow distribution plate divided into four quadrants:

$$\begin{matrix}( \frac{Δ P\_h}{Δ P\_p} ) \geq R 1 = 20 ; & EQ . 1 \\ 0.10 \leq [ Nh \cdot {( \frac{Dh}{Di} )}^{2} ] \leq R 2 = 0.21 ; & EQ . 2 \\ 0.01 \leq ( \frac{Dh}{Di} ) \leq 0.10 ; and & EQ . 3 \\ 5 \leq ( \frac{vh}{vi} ) \leq 11 \; 2 \leq ( \frac{vi}{vp} ) \leq 16 , & EQ . 4\end{matrix}$$

where vh is the velocity in holes 208, vi is the velocity at inlet 202, and vp is the velocity in the volume enclosed by housing 200.

Continuing with the above example, from EQ. (4), let

$$vh \geq ( \frac{5 + 10}{2} ) \cdot ( vi ) = 7.5 \cdot [ \frac{mf}{ρ c \cdot ( \frac{π}{4} \cdot {Di}^{2} )} ] = 92.5 ( \frac{m}{sec} ) , and$$

$$vi = \frac{vh}{7.5} = \frac{9.25}{7.5} = 12.33 ( \frac{m}{sec} ) .$$

By keeping the volume small,

$$vp = \frac{vi}{5} = 2.47$$

(m/s) and

$$Δ P\_h \geq 20 \cdot Δ P\_p = 1.5 \cdot ( \frac{ρ c}{2} ) \cdot {( 92.5 )}^{2} 1.5 \cdot ( \frac{ρ c}{2} ) \cdot {( 92.5 )}^{2} = 7699 \text{)}$$

(Pascals). Combining equations 2 and 3 above with vh gives:

$$Nh\_avg \cdot ( Cd \cdot \frac{π}{4} \cdot {Dh\_avg}^{2} \cdot ρ c \cdot vh ) = [ Cd \cdot \frac{π}{4} \cdot ( 0.21 \cdot {Di}^{2} ) \cdot ρ c \cdot vh ] .$$

But, from equation 3 above, Dh average equals 0.04·Di. Thus the resultant hole count is

$$Nh\_avg = \frac{0.21 \cdot {Di}^{2}}{{( 0.04 \cdot Di )}^{2}} = 130$$

Holes. From equation 2, with Di equal to 50.8 mm, the resultant hole diameter is

$$Dh \geq Di \cdot \sqrt{\frac{0.21}{Nh}} = 50.8 \cdot \sqrt{\frac{0.21}{130}} = 2.042 mm = 0.08 inches .$$

From equation 4, the ratio vh/vi equals 5 for minimum volume. Using this ratio,

$$vp \leq ( \frac{1}{5} ) \cdot vi = ( \frac{1}{5} ) \cdot [ \frac{mf}{ρ c \cdot ( \frac{π}{4} \cdot {Di}^{2} )} ] = 2.467 ( \frac{m}{sec} ) ,$$

and

$$W \cdot H \geq \frac{mf}{ρ c \cdot ( 2.467 )} = 0.010 {m}^{2} .$$

If the width W of housing 200 is twice the height H of housing 200

$$H = \sqrt{\frac{0.010}{2}} = 71 \_mm = 2.8 \_inches ,$$

and W equals 5.6_inches.

The following empirical table (TABLE 1) may be used to find an appropriate hole distribution for flow distribution plate 206. Since for the above example

$$\frac{vh}{vp} = \frac{92.5}{2.47} = 37.5 ,$$

column “C” of Table 1 is selected.

TABLE 1
Percent-Of-Holes In Plate For Uniform Flow Distribution

| | A | B | C | D | E | F | G |
|---|---|---|---|---|---|---|---|
| PlatePercent-Length | $10 \leq ( \frac{vh}{vp} ) \leq 20$ | $20 < ( \frac{vh}{vp} ) \leq 30$ | $30 < ( \frac{vh}{vp} ) \leq 40$ | $40 < ( \frac{vh}{vp} ) \leq 60$ | $60 < ( \frac{vh}{vp} ) \leq 100$ | $100 < ( \frac{vh}{vp} ) \leq 160$ | $160 < ( \frac{vh}{vp} ) \leq 255$ |
| 0-25% | 43% | 40% | 37% | 34% | 31% | 28% | 26% |
| 25-50% | 39% | 36% | 33% | 30% | 27% | 26% | 25% |
| 50-75% | 11% | 14% | 17% | 20% | 23% | 24% | 25% |
| 75-100% | 7% | 10% | 13% | 16% | 19% | 22% | 24% |
| | 100% | 100% | 100% | 100% | 100% | 100% | 100% |

Using column C of Table 1, and the fact that the total number of holes needed for the example is 130, the number of holes for each of the four quadrants of flow distribution plate 206 is 48, 43, 22, and 17, respectfully, as shown in the table below (TABLE 2).

TABLE 2

| | | |
|---|---|---|
| Plate%-Length | $30 < ( \frac{vh}{vp} ) \leq 40$ | HOLES |

| | | | |
|---|---|---|---|
| 0-25% | 37% | 0.37 · 130 = | 48 |
| 25-50% | 33% | 0.33 · 130 = | 43 |
| 50-75% | 17% | 0.17 · 130 = | 22 |
| 75-100% | 13% | 0.13 · 130 = | 17 |
| | 100% | | 130 |

FIG. 4 is a schematic diagram showing the flow of gas through nozzle 130. As shown in FIG. 4, a plurality of flow conditioning channels 400 are located in a portion of housing 204. A space 402 exists in housing 204 between the ends of flow conditioning channels 400 and flow distribution plate 206. In an embodiment, wherein holes 208 of flow distribution plate 206 have a diameter D, the end of each flow distribution channel 402 is located at least a distance ten D from the surface of flow distribution plate 206.

In an embodiment, gas flows into first housing 200 via inlet 202 at a velocity v₁. As gas enters further into housing 200, it slows to a velocity v₂. The gas exits housing 200 via holes 208 in flow distribution plate 206 at a velocity v₃. The relationship between these velocities was described above by way of the example. In space 402, the velocity of the gas flow is v₄. The gas flow enters flow conditioning channels 400 and exits flow conditioning channels 400 with a velocity v₅.

The gas is forced to flow laminarly through flow conditioning channels 400, which have a prescribed length necessary to attenuate non-axial velocity flow-vectors such that the exiting flow-field is axially directional and encouraged to maintain its stream-tube direction (throw) for an extended distance after it exits flow conditioning channels 400. The resultant flow-field behaves as laminar (e.g., Reynolds Number much less than 2000) streamline flow, where the possibility of mixing occurring between streamlines is minimal over the effective “throw” distance. The laminar, streamline flow exiting flow conditioning channels 400 is ideally suited to efficiently refresh contaminated gaseous volumes and to control point heat sources.

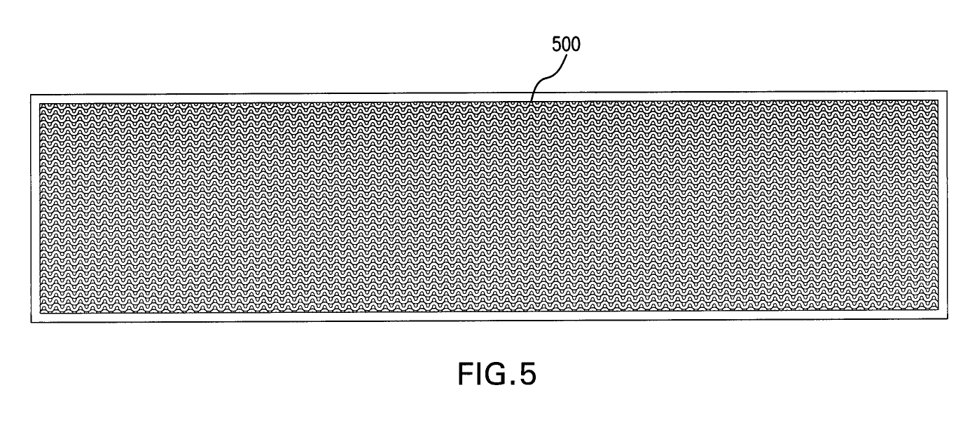

As shown in FIG. 5, in an embodiment, the plurality of flow conditioning channels are formed by a plurality of appropriately shaped plates 500. This simplifies the manufacturing of the flow conditioning channels. In other embodiment, each flow conditioning channel is formed, for example, by an individual tube.

The following two examples illustrate how to select appropriate parameters for flow conditioning channels according to embodiments of the present invention. In following the design criteria of these examples, it is possible to create a gas curtain having optimized performance, while utilizing minimum amounts of gas flow. The design criteria are based on minimizing jet-curtain turbulence and thereby reducing the amount of mixing between constant temperature curtain-gas (e.g., an air curtain) and hot ambient gases (e.g., environmental air). These design examples can be used to prevent index of refraction changes within a selected control volume.

For purposes of these examples, the flow conditioning channels are assumed to be honeycomb-shaped, as shown in FIG. 5. Each honeycomb cell acts as an independent 2-D jet such that the overall height and width of housing 204 does not influence the effective performance of each axial jet. Local air curtain honeycomb flow uniformity can be assured, for example, by using a foam material as a back-pressuring device ahead of the honeycomb flow conditioning channels (in a portion of space 402 shown in FIG. 4).

### First Example in Selecting Flow Conditioning Channel Parameters

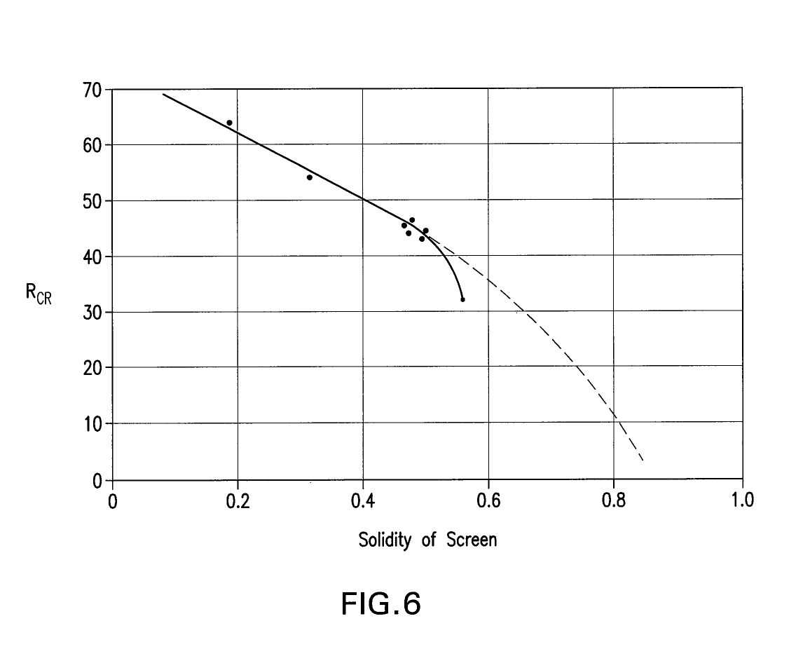

In reference to the first example in selecting appropriate parameters for flow conditioning channels, it is known that slot turbulence is minimized and/or non-existent at Reynolds numbers (Res) less than or equal to 70 for a honeycomb solidity ratio of 0.098 (i.e., R_{cr} (0.098)=70.504 per the following equation). (See also, e.g., FIG. 13 of the National Advisory Committee For Aeronautics, Technical Note 2001, Aerodynamic Characteristics of Damping Screens, National Bureau of Standards (January 1950), which is reproduced herein as FIG. 6). This ensures the flow-field is within a laminar flow regime. The Reynolds critical number as a function of solidity ration (sol) is given by:

R_{cr}(sol)=79.7−108(sol)+169.5 (sol)²−177.72(sol)³, where 0≦(sol)≦0.85.

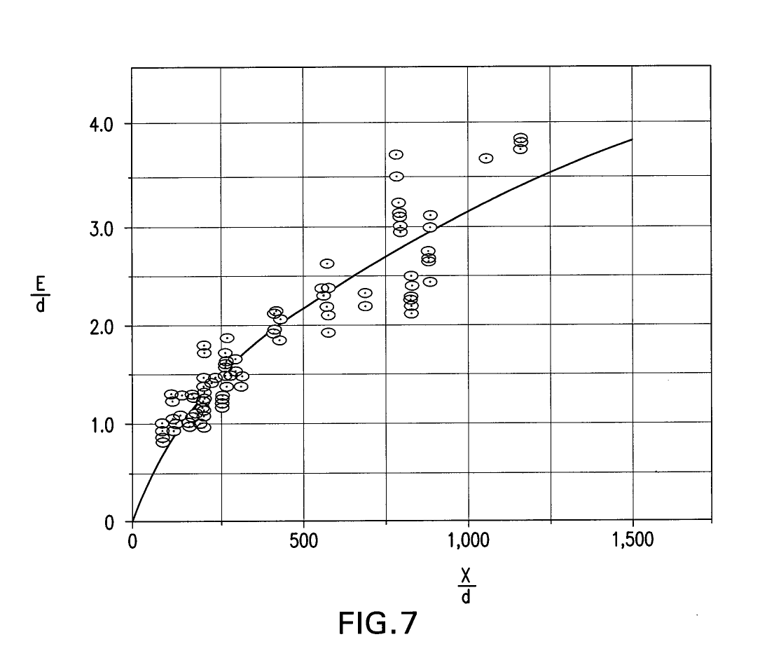

When transitioning from laminar to turbulent flat-plate gas curtain flow, the scale of shedding vortices downstream of the honeycomb gas injection slot is minimized over the length to be film protected when E/d is less than or equal to 1.0. (See, e.g., figure K-2 of H. L. Dryden “A Review of the Statistical Theory of Turbulence,” Quart. Appl. Math., Vol. 1, No. 1 (April 1943), which is reproduced herein as FIG. 7). The value E/d is given by:

E/d=9.2*10⁻³·(X/d)−10.0*10⁻⁶·(X/d)²+3.7*10⁻⁹·(X/d)³

$$where 0 \leq ( \frac{X}{d} ) \leq 1500 , for \frac{E}{d} \leq 1 \frac{X}{d} \leq 125.$$

Therefore, by knowing “X” (the length to be film protected, e.g., 20 inches), the hydraulic flow-tube diameter, “d”, is defined or capped as a max-limit, and the flow rate is sized such that Re_{d}=U1*d/v≦Res. For X equal to 20 inches,

$$d \geq \frac{X}{125} = \frac{20}{125} = 0.16 .$$

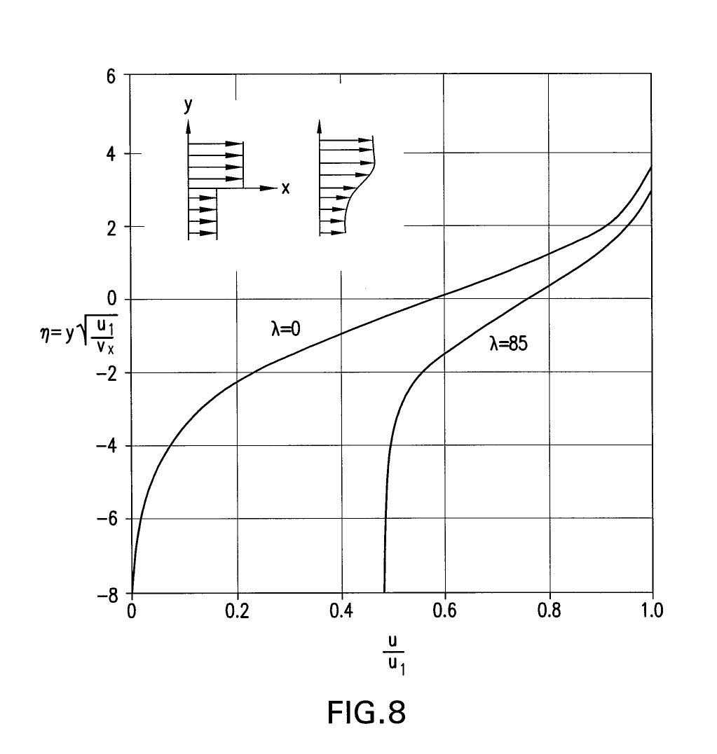

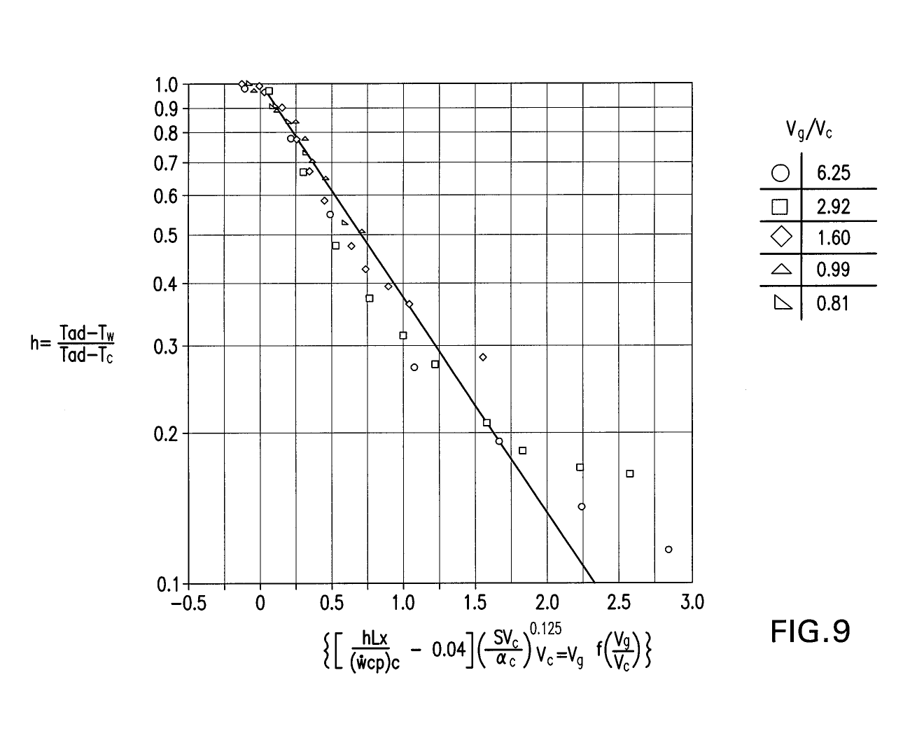

For a given Re_{d} value, the corresponding injection film velocity “U1” is determined. This can be accomplished, for example, using available thermodynamic graphs. (See, e.g., FIG. 9.15 of H. Schlichting “Boundary Layer Theory,” 6^{th} Ed., McGraw Hill Inc, which is reproduced herein as FIG. 8). For Re_{d}=U1*d/v≦Res, where Res is the actual stream-tube Reynolds number, the corresponding injection film velocity U1 is determined from FIG. 8 for a total allowable slot height of y equals 50 mm, u equals 0.20*U1 (a 20% maximum allowable boundary layer mixing velocity for two interacting parallel streams), and h equals 2.4 (the quiescent ambient mixing flow-stream spreading factor for laminar boundary layers corresponding to u/U1=0.20) to be 0.95 ft/s (290 mm/s).

The corresponding injection film velocity “U1” may also be cross-checked or found using the Hatch & Papell turbulent film cooling correlation, as modified for laminar flow. (See FIG. 5 of Hatch, J. E. and Papell, S. S., “Use of a Theoretical Flow Model to Correlate Data for Film Cooling or Heating an Adiabatic Wall by Tangential Injection of Gases of Different Fluid Properties,” TN D-130, 1959, NASA, which is reproduced herein as FIG. 9.) For laminar flow, hₓ=0.332 Reₓ^{1/2} Pr^{1/3}, where 50<Reₓ<5*10⁵. The resulting modified laminar film coolant flow effectiveness required is thus η=(1−u/U1)=0.8.

To check the result for U1 determined above, the following equations are used and solved (e.g., iteratively) for a given L, X, y, Cp_{c}, μ_{c}, k_{c}, η_{c}.

$$\begin{matrix}η = ( 1 - \frac{u}{U 1} ) = 0.8 \\ = exp [ \begin{matrix}[ \frac{0.332 \cdot {[ {( \frac{Cp \cdot μ}{k} )}_{c} ]}^{\frac{1}{3}} \cdot {( \frac{{w}_{c} \cdot X}{μ \cdot L \cdot y} )}^{\frac{1}{2}} \cdot L X}{( w \cdot {Cp}_{3} )} - 0.04 ] \\ {[ \frac{{( \frac{{w}_{c}}{L} )}^{2}}{{( k \cdot ρ \cdot y )}_{c}} ]}^{\frac{1}{8}}\end{matrix} ]\end{matrix}$$

where
L=slot width (m)
X=axial distance downstream from slot (m)
y=slot height (m)
Cpc=coolant specific heat (J/kg−K)
μ_{c}=coolant dynamic viscosity (kg/m−sec)
k_{c}=coolant thermal conductivity (W/m−K)
ρ_{c}=coolant density (kg/m3)
U1=center-line coolant velocity (m/sec), and

$$U 1 ( ρ c , μ c , X , y , η s ) := {( \frac{η s}{y} )}^{2} \cdot X \cdot ( \frac{μ c}{ρ c} ) .$$

For the example where X=55.0 mm, ηs=2.4, y=4.0 mm, and L=90.8 mm, U1(ρ_{c}, μ_{c}, X, y, ηs)=0.293 m/s. This confirms the value of 290 mm/s determined above using FIG. 8.

Having determined the value of U1, it is now possible to establish a hydraulic diameter for the U1 velocity and laminar flow-field. The scale of shedding vortices (E/d) downstream of the honeycomb flow conditioning channels (see FIG. 7) is directly proportional to the laminar boundary velocity mixing ratio u/U1=0.2 (see FIG. 8). Having established an allowable velocity mixing ratio of 0.2, one can attribute this value to E/d=0.2. Therefore, the value “X/d” is found from FIG. 7 as 125. For X equal to 20″, this gives a value of d equal to 20/125 or 0.16 m.

From FIG. 6, and the equation:

R_{cr}(sol)=79.7−108(sol)+169.5(sol)²−177.72(sol)³

where 0≦(sol)≦0.85, R_{cr}(0.15)=66.6 and R_{cr}(0.23)=61.5. Thus, for a honeycomb solidity ratio of 15 percent,

$${Re}_{d} = \frac{ρ c \cdot U 1 \cdot d}{μ c} \leq 66.6 ,$$

and for a honeycomb solidity ratio of 23 percent,

$${Re}_{d} = \frac{ρ c \cdot U 1 \cdot d}{μ c} \leq 61.5 .$$

The actual stream-tube Reynolds Number for d-minimum is

$$\frac{ρ c \cdot U 1 ( ρ c , μ c , X , y , η s ) d min}{μ c} = 1.153 \times {10}^{6} .$$

For purposes of this example, however, d is made equal to 0.032 so that

$${Re}_{H} := \frac{ρ c \cdot U 1 ( ρ c , μ c , X , y , η s ) d}{μ c}$$

or 1.153*10⁶. Then, given a honeycomb wall thickness (tw) of 0.05 mm (2 mils), the number of honeycomb flow control channels Nc is

$$\frac{4 \cdot L \cdot y}{π \cdot {( d K + tw )}^{2}}$$

or 621. That is to say for honeycomb flow conditioning channels fitting into a housing 204 of height y=4 mm and L=90.8 mm, and having wall thickness of 0.05 mm with an inner diameter of 0.813 mm, there should be a total of 621 flow conditioning channels. The solidity ratio for the values of this example is

$$S ( y , L , tw , d , Nc ) := \frac{Nc \cdot [ π \cdot ( dK + tw ) \cdot tw ]}{y \cdot L} or 23 \% .$$

As noted above, the critical Reynolds number is R_{cr}(0.23)=61.5. In order to guarantee this number, it is preferable to use the d-minimum dimension to allow for margin. This margin is to account, for example, for geometric irregularities of the flow conditioning channels and possible local turbulence-mixing anomalies.

The total required coolant flow based on the established values for d-minimum and U1 is wc:=ρc·U1(ρc, μc, X, y, ηs)·Ac, where

$$Ac = Nc \cdot \frac{π}{4} \cdot {d}^{2} .$$

Solving for wc, the total gas flow requirement is 0.041 kg/s.

Tests of the throw capability and arrival velocity of nozzle 130, according to the embodiment described above, were conducted using honeycomb flow conditioning channels having a length-to-diameter (L/D) ratio of 35 and 40, with a channel diameter of ⅛″. These tests show that nozzle 130 performs best when the flow conditioning channels have an exit Reynolds number of 100 or less and that nozzle-throw performance is increased when the exit velocities of individual flow conditioning channels are within about +/−15-20% of the average exit velocity of the flow conditioning channels. It is noted, however, that other values and/or ranges of values can be used. These tests also show that (1) gas nozzle 130 can reduce purge gas consumption compared to conventional gas curtain system by at least a factor of five, (2) the purge gas is prevented from mixing with environmental gas during purging and allows purge displacement to be more piston-like, (3) the purge gas is able to handle cross-winds from any directional source, (4) the purge gas neutralizes any cross-wind velocity vectors typically experienced within a lithographic tool wafer stage; (5) the purge gas can accommodate asymmetric cross-winds, (6) the purge gas provides a thermally stable environment while simultaneously purging and cooling various heat sources; and (7) the purge gas is not easily dispersed nor mixed when encountering other flow-fields. These advantages are due, in part, to the fact that the purge gas exiting nozzle 130 presents a high-energy, directional flow-field that can dominate over other purge processes. Additional advantages of the present invention will become apparent to those skilled in the relevant art given the description herein.

### Second Example in Selecting Flow Conditioning Channel Parameters

The following example illustrates a selection of parameters for flow conditioning channels according to another embodiment of the present invention. In this embodiment, the selection process can be outlined in two steps. Similar to the first example described above, this example also assumes that the flow conditioning channels are honeycomb-shaped.

In the first step of the selection process, four features of the flow conditioning channel geometry can be defined. These four features relate to the following factors: gas curtain kinetic power requirements versus coverage; nozzle inlet pressure requirements; nozzle exit Reynold's number; and, attenuation of unwanted nozzle inlet velocity vectors.

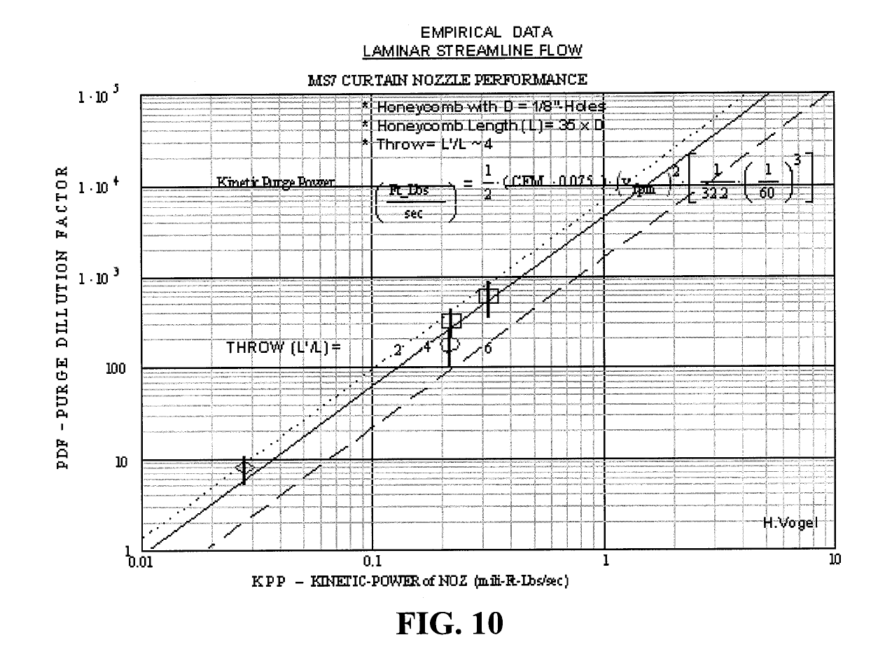

With respect to gas curtain kinetic power requirements versus coverage, preliminary results of an initial kinetic power required to move a gas over a known protection distance with a final axial velocity are illustrated in FIG. 10, according to an embodiment of the present invention. This graph illustrates a gas curtain throw distance (L′) as a function of flow conditioning channel length (L), kinetic purge power (KPP), and purge dilution factor (PDF). The ordinate is expressed as PDF, which can provide information to predict universal variables such as, for example, an amount of average mixing that occurs within a gas curtain volume or an expected local variation of constituents such as gas temperature, pressure, and concentration as a function of initial ambient conditions. These correlations can be based on a combination of testing and numerical methods. In addition, the correlations can be derived from assumptions on mixing, deterioration, and axial velocity degradation based on an exit-jet diffusion angle in axi-symmetric jets.

With respect to nozzle inlet pressure requirements, an amount of pressure available at the nozzle inlet to move and purge gas at a specified velocity can be determined. In an embodiment, this gas pressure can be used to accommodate pressure (e.g., energy) losses throughout the nozzle, including, for example, a gas curtain traveling distance beyond an exit of the nozzle.

With respect to the nozzle exit Reynold's number (Re), in an embodiment optimal nozzle designs for gas curtains can exhibit a nozzle exit Reynold's number between about 60 and 120 (e.g., 60<Re<120). This Reynold's number range can be based on a combination of testing and numerical methods.

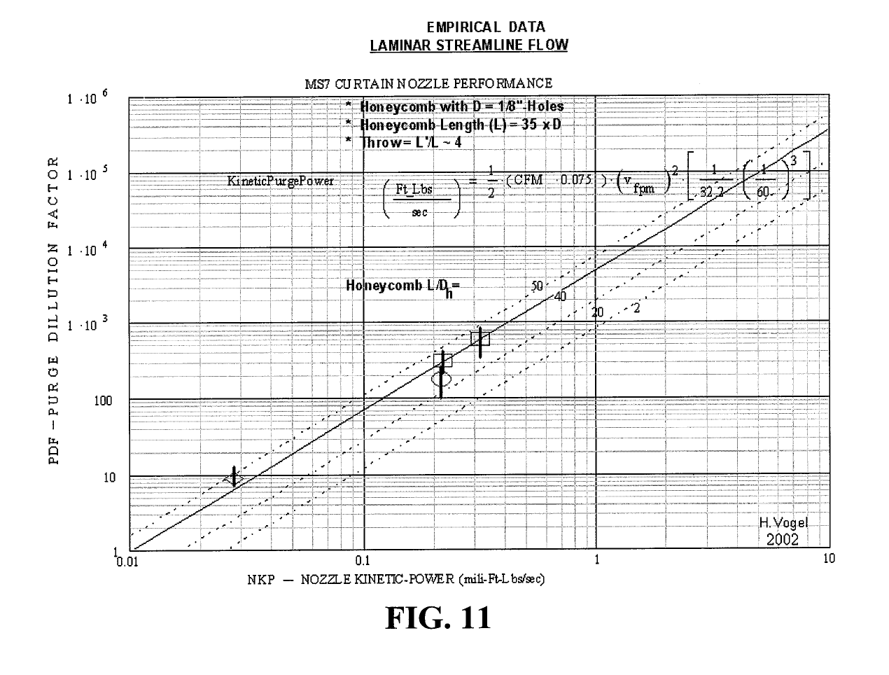

With respect to attenuation of unwanted nozzle inlet velocity vectors, an optimal flow conditioning channel can attenuate substantially all unwanted nozzle inlet velocity vectors (e.g., −Vₓ, ±V_{y}, and ±V_{z} vectors) to create a robust gas curtain design. In order to compensate for these unwanted velocity vectors, complexity of the nozzle design can increase where design features such as, for example, an inlet plenum for flow dump (e.g., element 402 in FIG. 4) and a distribution plate (e.g., element 206 in FIG. 2A) must be factored into the nozzle design process. In an embodiment, an alternative to compensating for such design features is to choose an appropriate flow conditioning channel length to channel diameter ratio to ensure proper flow distribution. FIG. 11 is an example graph illustrating flow conditioning channel length (L) as a function of diameter (D) of the flow conditioning channel, KPP, and PDF.

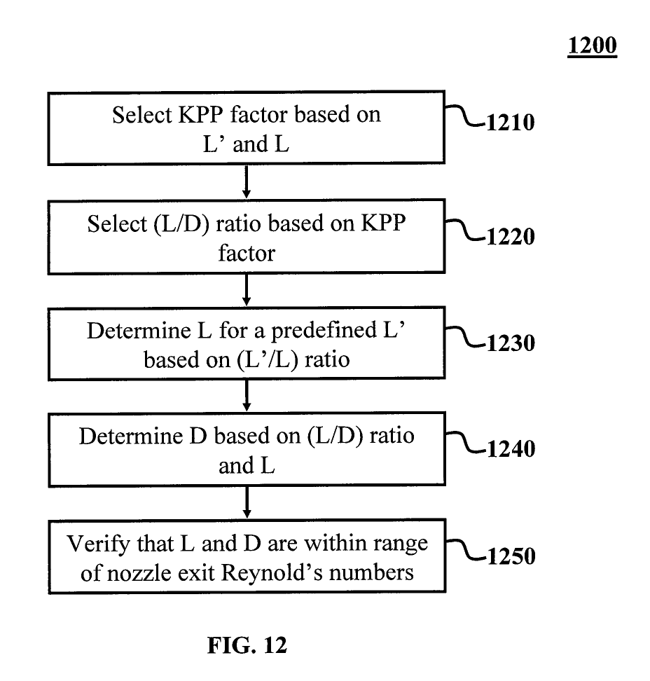

In the second step of the selection process, a flow conditioning channel can be designed based on the four factors described above. FIG. 12 is an illustration of a method 1200 to design the flow conditioning channel according to an embodiment of the present invention. In step 1210, a KPP factor is selected based on a predefined throw distance (L′) to channel length (L) ratio (L′/L). In an embodiment, PDF and predefined throw distance L′ can be predefined values, where length (L) and diameter (D) parameters of the flow conditioning channel can be based on these values. For exemplary purposes and to facilitate in the explanation of the selection process, the following values can be assumed: PDF=1000, L′=200 mm, and (L′/L)=4. With these assumptions, as shown in the graph illustrated in FIG. 10, KPP can be found to be 0.44 (mili-ft-lbs/sec), which is also equal to 4.4 E-04 (ft-lbs/sec). Based on the description herein, a person skilled in the relevant art will recognize that the values for PDF and the (L′/L) ratio are implementation specific and can vary based on a particular flow conditioning channel design.

In step 1220, a channel length (L) to channel diameter (D) ratio is selected based on the KPP factor. In an embodiment, once the KPP factor is found in step 1210, a channel length to diameter (L/D) ratio can be determined using the graph illustrated in FIG. 11. For instance, for a KPP factor of 0.44 (mili-ft-lbs/sec) and a PDF of 1000, the (L/D) ratio can be interpolated from FIG. 11 to provide a value of 35.

In step 1230, the channel length (L) is determined for a predefined throw distance (L′) based on the length to diameter (L/D) ratio. In an embodiment, based on the length to diameter (L/D) ratio found in step 1220, the predefined throw distance to channel length (L′/L) ratio defined above, and the assumption that L′=200 mm, L can be calculated to equal to 50 mm.

In step 1240, the channel diameter (D) is determined based on the length to diameter (L/D) ratio and the channel length L. In an embodiment, based on the length and diameter (L/D) ratio and channel length L derivations, channel diameter D can be calculated to equal to 0.71 mm. More specifically, the derivation of channel length L and diameter D is as follows:

L′=200 mm;

(L′/L)=(200 mm/L)=4

L=50 mm; and

(L/D)=(50 mm/D)=35

D=0.71 mm.

Step 1250 verifies that the channel length (L) and channel diameter (D) parameters calculated in steps 1230 and 1240, respectively, are within a predefined range of nozzle exit Reynold's numbers. In an embodiment, once the values for the flow conditioning channel length (L) and channel diameter (D) are determined, these values can be verified to ensure that these parameters are designed for optimum performance. As described above, with respect to the first step of the selection process, optimal channel designs for gas curtains can exhibit a nozzle exit Reynold's number (Re) between about 60 and 120, according to an embodiment of the present invention. The channel length and diameter values calculated above can be compared to a Re calculation to ensure an optimal channel design. For example, the calculated channel length and diameter values (e.g., L=50 mm and D=0.71 mm) can be compared to other exit Reynold's number values.

An equation for deriving a nozzle exit Reynold's number (Re) based on channel diameter can be the following:

$$Re = \frac{ρ \cdot {V}_{e} \cdot D}{μ} \qquad EQ . 8$$

where
ρ=coolant density (kg/m²);
Vₑ=exit velocity of the nozzle (ft/min); and
μ=coolant dynamic viscosity (kg/m-s).

Exit velocity (Vₑ) of the nozzle can be derived from EQ. 9, which can be based on the graph in FIG. 10.

$$KPP = ( \frac{CFM}{2} \cdot 0.075 ) \cdot ( \frac{1}{32.2} ) \cdot {( \frac{1}{60} )}^{3} \cdot {V}_{e}^{2} \qquad EQ . 9$$

Based on EQ. 9, Vₑ can be derived, which is shown in EQ. 10 below (note: Vₑ is represented in ft/min).

$${V}_{e} = {[ ( \frac{2 \cdot 32.2 \cdot {60}^{3}}{0.075} ) \cdot ( \frac{KPP}{A e \cdot ( 1 - s )} ) ]}^{1 / 3} \qquad EQ . 10$$

For a given nozzle design, nozzle exit area (Aₑ) and solidity ratio (s) can be predefined. For exemplary purposes and to facilitate in the explanation of the selection process, Aₑ can be assumed to be 500 mm² and s can be assumed to be 0.2. Thus, for a KPP factor of 1000, Vₑ is equal to 261 ft/min.

Further, assuming a coolant density of 0.075 (kg/m²) and a coolant dynamic viscosity of 1.2·10⁻⁵ (kg/m−s), the nozzle exit Reynold's number can be found according to EQ. 8, which is reproduced below.

$$Re = \frac{ρ \cdot {V}_{e} \cdot D}{μ} = \frac{( 0.075 ) \cdot ( 261 / 60 ) \cdot ( 0.71 / ( 25.4 \cdot 12 ) )}{( 1.2 \cdot {10}^{- 5} )} = 62$$

Since the nozzle exit Reynold's number calculated above is within the optimal range (e.g., 60<Re<120), according to an embodiment, the value of D and, in turn, the value of L can be considered acceptable values for an optimal flow conditioning channel design.

Based on the analysis above, channel length (L) and channel diameter (D) parameters can also be found for a specific Reynold's number such as, for example, a maximum Reynold's number (Reₘₐₓ) for a particular flow conditioning channel design. In an embodiment, the maximum Reynold's number for a channel design can be 120. In solving EQ. 8 for a maximum channel diameter (Dₘₐₓ) and applying the exit velocity (Vₑ) calculated above (e.g., 261 ft/min), Dₘₐₓ can be derived from the following:

$$\begin{matrix}{D}_{max} = ( \frac{μ}{ρ \cdot {V}_{e}} ) \cdot {Re}_{max} \\ = [ \frac{1.2 \cdot {10}^{- 5}}{0.075 \cdot ( 261 / 60 )} ] \cdot ( 120 ) = 4.4 \cdot {10}^{- 3} ft = 135 mm\end{matrix}$$

Further, in using the (L/D) ratio derivation above (in step 1220), a maximum channel length (Lₘₐₓ) can be derived from the following:

(Lₘₐₓ/Dₘₐₓ)=35

Lₘₐₓ=35·Dₘₐₓ

Lₘₐₓ=35·(1.35 mm)=47.25 mm.

Therefore, the flow conditioning channel length and diameter can be designed to be 1.35 mm and 47.25 mm, respectively, in order to achieve a Reynold's number of 120.

In summary, based on the calculations above for flow conditioning channel parameters based on a Reynold's number of 120, an exemplary final set of gas curtain nozzle parameters can be defined as follows:

Reₘₐₓ=120;

Dₘₐₓ=1.35 mm;

Lₘₐₓ=35·Dₘₐₓ=47.3 mm;

Vₑ=261 (ft/min);

$$\begin{matrix}{A}_{e} = [ ( {W}_{n} \cdot {H}_{n} ) \cdot {( \frac{1}{25.4} \cdot \frac{1}{12} )}^{2} ] \\ = [ ( 10 \cdot 50 ) \cdot {( \frac{1}{25.4} \cdot \frac{1}{12} )}^{2} ] \\ = 5.4 \times {10}^{- 3} ( {ft}^{2} )\end{matrix}$$

$$\begin{matrix}CFM = ( {A}_{e} ) \cdot ( 1 - s ) \cdot ( {V}_{e} ) \\ = [ ( 10 \cdot 50 ) \cdot {( \frac{1}{25.4} \cdot \frac{1}{12} )}^{2} ] \cdot ( 1 - 0.15 ) \cdot ( 261 ) \\ = 1.2 ( \frac{{ft}^{3}}{min} )\end{matrix}$$

$$KPP = ( \frac{1.2}{2} \cdot 0.075 ) \cdot ( 1.4 \times {10}^{- 7} ) \cdot {( 261 )}^{2} = 4.4 \times {10}^{- 4} ( \frac{ft \cdot lb}{sec} )$$

Wₙ and Hₙ are width and height values for the nozzle exit area (Aₑ). For the exemplary final set of gas curtain nozzle parameter, Wₙ and Hₙ can be assumed to be 10 mm wide and 50 mm high, respectively, in order to provide an Aₑ of 500 mm. A person skilled in the relevant art will recognize that Wₙ and Hₙ, and in turn Aₑ, can vary in values according to a particular nozzle implementation.

### CONCLUSION

While various embodiments of the present invention have been described above, it should be understood that they have been presented by way of example, and not limitation. It will be apparent to persons skilled in the relevant art(s) that various changes can be made therein without departing from the scope of the invention. Furthermore, it should be appreciated that the detailed description of the present invention provided herein, and not the summary and abstract sections, is intended to be used to interpret the claims. The summary and abstract sections can set forth one or more but not all exemplary embodiments of the present invention as contemplated by the inventors.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method, comprising:
selecting a kinetic purge power (KPP) factor based on a predefined throw distance (L′) to a channel length (L) ratio (L′/L);
selecting the channel length (L) to a channel diameter (D) ratio (L/D) based on the KPP factor;
determining the channel length L for the predefined throw distance L′ based on the (L′/L) ratio; and
determining the channel diameter D based on the channel length to the channel diameter (L/D) ratio and the channel length L.

2. The method of claim 1, further comprises verifying that the channel length L and the channel diameter D are within a predetermined range of nozzle exit Reynold's numbers for a nozzle.

3. The method of claim 2, wherein the verifying that the channel length L and the channel diameter D are within the range comprises determining the nozzle exit Reynold's number (Re) using
$$Re = \frac{ρ \cdot {V}_{e} \cdot D}{μ}$$
wherein ρ is a gas density parameter, Vₑ is an exit gas velocity of the nozzle, and μ is a gas dynamic viscosity parameter.

4. The method of claim 2, wherein the range of the nozzle exit Reynold's number is between about 60 and 120.

5. The method of claim 1, further comprises determining the channel length L and the channel diameter D for a predefined Reynold's number.

6. The method of claim 5, wherein the predefined Reynold's number is a maximum nozzle exit Reynold's number.

7. The method of claim 1, wherein the selecting the KPP factor comprises selecting the predefined throw distance to the channel length (L′/L) ratio from a correlation between a purge dilution factor and the KPP factor of a nozzle used to move air or gas at a specified velocity.

8. The method of claim 1, wherein the selecting the channel length L further comprises selecting the channel length to the channel diameter (L/D) ratio based on a predefined purge dilution factor.

9. A lithographic apparatus, comprising:
an illumination source configured to emit an illumination energy;
a spatial light modulator configured to receive the illumination energy;
projection optics configured to receive an illumination energy reflected from the spatial light modulator; and
a wafer stage configured to receive the illumination energy from the projection optics,
wherein the wafer stage comprises a gas curtain having a nozzle designed based on,
selecting a kinetic purge power (KPP) factor based on a predefined throw distance (L′) to a channel length (L) ratio (L′/L);
selecting the channel length (L) to a channel diameter (D) ratio (L/D) based on the KPP factor;
determining the channel length L for the predefined throw distance L′ based on the (L′/L) ratio, and
determining the channel diameter D based on the channel length to the channel diameter (L/D) ratio and the channel length L.

10. The lithographic apparatus of claim 9, wherein the gas curtain having the nozzle is further configured to be designed based on verifying that the channel length L and the channel diameter D are within a predetermined range of nozzle exit Reynold's numbers for a nozzle.

11. The lithographic apparatus of claim 9, wherein the gas curtain having the nozzle is further configured to be designed based on determining the channel length L and the channel diameter D for a predefined Reynold's number.

12. The lithographic apparatus of claim 9, wherein
the wafer stage further comprises a plurality of interferometers configured to control x- and y-movements of the wafer stage; and
the gas curtain having the nozzle is configured to prevent ambient air or some gas from penetrating and mixing with one or more controls of the plurality of interferometers.
